(19) United States
(12) Patent Application Publication
(10) Pub. No.: US 2024/0408981 A1
(43) Pub. Date: Dec. 12, 2024

(54) Arrangement for Establishing an Electrical Connection of a Stored Energy Source

(71) Applicant: ZF Friedrichshafen AG, Friedrichshafen (DE)

(72) Inventor: Finn Neumann, Blaustein (DE)

(21) Appl. No.: 18/702,597

(22) PCT Filed: Oct. 18, 2022
(86) PCT No.: PCT/EP2022/078888

§ 371 Date: Apr. 18, 2024

(30) Foreign Application Priority Data
Oct. 19, 2021 (DE) 10 2021 211 776.7

(51) Int. Cl. B60L 50/64; H01M 50/249; H01M 50/296

(52) U.S. Cl. CPC B60L 50/64; H01M 50/249; H01M 50/296; B60L 2200/12

(57) ABSTRACT

An arrangement for establishing an electrical connection of a stored energy source (14) to electrical components of a two wheeled vehicle includes a coupling unit (12) to which the stored energy source is detachably fastened and a connection module (26) for electrically connecting components of the two-wheeled vehicle. The connection module (26) is detachably connected to the coupling unit (12). The connection module (26) has a plug interface (24) to an electrical plug connector (44) of the stored energy source (14). The connection module (26) has at least one connection interface (30) for coupling terminal connectors (58) of components of the two-wheeled vehicle to the connection module (26) and for supplying the components of the two-wheeled vehicle with energy from the stored energy source (14).

### CROSS-REFERENCE TO RELATED APPLICATIONS

The present application is related and has right of priority to German Patent Application No. DE102021211776.7 filed in the German Patent Office on Oct. 19, 2021 and is a US national phase of PCT/EP2022/078888 filed in the European Patent Office on Oct. 18, 2022, both of which are incorporated by reference in their entireties for all purposes.

### TECHNICAL FIELD

The present invention relates generally to an arrangement for establishing an electrical connection between a stored energy source and electrical components of a two-wheeled vehicle.

### BACKGROUND

Arrangements for establishing an electrical connection are known, for example, from DE 10 2019 204 572 B3, in which an electrical connection by a locking device for locking an energy supply unit for a bicycle is proposed. An energy supply unit is a stored energy source, such as a rechargeable battery or an accumulator, which is used in conjunction with electric two-wheeled vehicles, such as bicycles or pedelecs. It is used to supply one or more electric motors of the two-wheeled vehicle or other electrical components.

The central units integrated in the locking devices include a fixed interface between the removable stored energy source and the components of the bicycle.

Based on this, there is a need for a more flexible connection between the components of the two-wheeled vehicle and the energy storage system used.

### BRIEF SUMMARY

According to a first example aspect, the invention relates to an arrangement for establishing an electrical connection of a stored energy source to electrical components of a two-wheeled vehicle. The arrangement includes a coupling unit to which the stored energy source is detachably fastened and a connection module for electrically connecting components of the two-wheeled vehicle. The connection module is detachably connected to the coupling unit, and the connection module has a plug interface to an electrical plug connector of the stored energy source. The connection module has at least one connection interface for coupling terminal connectors of components of the two-wheeled vehicle to the connection module and for supplying the components of the two-wheeled vehicle with energy from the stored energy source.

According to a further example aspect, the present invention relates to an electric two-wheeled vehicle including an arrangement as described above.

It is to be understood that the above-mentioned features and the features to be explained below can be used not only in the particular combination indicated, but also in other combinations or in an exclusive position, without departing from the scope of the present invention.

The arrangement according to example aspects of the invention has the advantage that the coupling unit, by which the stored energy source is coupled to the two-wheeled vehicle, and the connection module are detachably connected and the connection module can be separated from the coupling unit. This means that different connection modules can be used while the coupling unit remains unchanged. The coupling units can therefore be produced in large quantities and are correspondingly inexpensive. Adapted connection modules can be used to respond to the specific requirements of individual two-wheeled vehicles. The holding function for the stored energy source provided by the coupling unit and the function of the electrical connection between the stored energy source and the electrical components of the two-wheeled vehicle are realized in two separate components.

The connection module forms a transformation unit in which various terminal connectors of individual components of the two-wheeled vehicle are tailored and adapted to the plug connector of the energy storage system. By separating the connection module from the coupling unit, batteries and stored energy sources having different electrical connectors can be used in an electric two-wheeled vehicle without having to replace the entire coupling unit. Only the connection module can be replaced by other connection modules having a suitable plug connection and adapted plug interface. By selecting a suitable connection module, the coupling unit can be individually adapted to different electric two-wheeled vehicles. As the coupling unit does not have to be modified, it can be produced in larger quantities and at lower cost.

In addition to a retainer, the coupling unit generally also includes components for fixing the stored energy source to the vehicle frame. Advantageous example embodiments of the coupling unit provide a lever or lever mechanism with which the stored energy source can be fixed to the coupling unit. As a rule, the coupling unit is connected to the frame of the electric vehicle, wherein corresponding receptacles and recesses are often provided in the vehicle frame.

In a preferred example embodiment of the arrangement according to example aspects of the invention, it is provided that the connection module is integrated in the coupling unit, so that a compact component is created. Alternatively, the connection module can be coupled or flange-mounted to the coupling unit, wherein the integrated version is preferred, as the available installation space is used in the best possible way.

In a preferred example embodiment, the connection module is designed in the form of a plate (module plate). The plate can be inserted into a corresponding recess in the coupling unit. The recess can be provided, for example, on a front face of the coupling unit that faces away from the front of the stored energy source. Preferably, the contour of the plate is designed so that the plate can be inserted precisely into the recess of the coupling unit. Preferably, the recess in the coupling unit and the connection module in the form of a plate are matched to each other in such a way that the top of the plate is flush with the coupling unit. For example, the coupling unit can be clamped into the recess so that a form fit or press fit is achieved. Alternatively and preferably, the connection module is screwed into the recess of the coupling coupling unit to ensure a secure fit and permanent hold.

In a preferred example embodiment, the plug-in connection and the terminal connection of the connection module are arranged on opposite sides of the plate. Preferably, the plug connection is arranged on the side of the plate that faces the coupling unit. The terminal connection is provided on the side of the plate facing away from the coupling unit.

Preferably, the plug interface includes a plug that corresponds to the plug connector of the stored energy source and can be coupled so that an electrical connection to the stored energy source can be established. Alternatively, the plug interface can be designed as a corresponding socket.

Preferably, the coupling unit has a guide channel into which the plug interface or the plug of the connection module extends at least partially. The guide channel creates a guided connection between the plug and the electrical plug connector of the stored energy source. This ensures that the plug connector can make contact with the plug of the connection module reliably and without mechanical resistance. This is particularly important because the stored energy source is moved relative to the coupling unit when the stored energy source is fixed in the electric two-wheeled vehicle. In this way, the plug connector of the stored energy source is securely fed to the plug of the connection module without jamming.

In a preferred example embodiment, the connection module has a connection plug that corresponds to the terminal connector of the component. Preferably, the connection plug is designed with a collar for receiving and holding the terminal connector of the component. The collar allows the terminal connector to be guided so that the two components can be connected easily and a secure and reliable hold is ensured at the same time. Preferably, the collar has a latching connection to the terminal connector of the component, so that unintentional detachment of the electrical connection is impossible.

Preferably, the connection plug has a pin that corresponds to a socket on the connector. The pin can be accommodated in the socket of the terminal connector and thus ensures that a reliable electrical contact is established.

Both the pin and the collar of the connection plug ensure good guidance and good contact. In addition, an individual design for these elements can serve to prevent the terminal connector and connection plug from being mixed up.

Preferably, the connection module has a large number of connection plugs. This makes it possible for a connection plug to be available for each terminal connector of a component and for a unique connection to be established, for example by selecting specially configured connection modules.

Electric two-wheeled vehicles include electric bicycles, bicycles with electric auxiliary drive or pedelecs, as well as e-scooters, electrically powered scooters, electric motorcycles and the like. Stored energy sources are, for example, rechargeable batteries or accumulators. They are used, for example, to supply one or more electric motors of the two-wheeled vehicle, which are part of an electric-motor-assisted drive, and other components, such as operating elements (human-machine interface, HMI), ABS unit, navigation system, lights or externally connected devices, such as cell phones.

### BRIEF DESCRIPTION OF THE DRAWINGS

Example aspects of invention are described and explained in more detail below with reference to some selected exemplary embodiments in conjunction with the accompanying drawings, in which:

FIG. 1 shows a holding device with two possible stored energy sources;

FIG. 2 shows an arrangement with coupling unit and separate connection module;

FIG. 3 shows another embodiment of a coupling unit; and

FIG. 4 shows another view of the coupling unit from FIG. 3.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

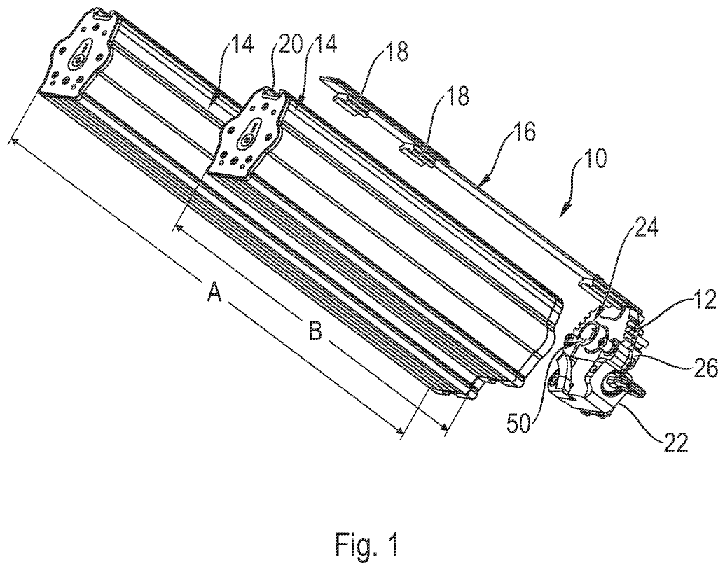

FIG. 1 shows a holding device 10 with a coupling unit 12 and two stored energy sources 14 of different lengths, both of which can be coupled to the holding device 10 and can be held in the holding device 10. The holding device 10 includes a holding rail 16 with guide elements 18 which engage in a groove 20 in order to fasten the stored energy sources 14, which are in the form of a battery, to the holding rail 16. The electrical stored energy sources 14 can be rechargeable batteries or accumulators.

In addition to a lockable actuating lever 22, the coupling unit 12 includes a locking lever that can be moved with said actuating lever and engages in a recess provided in the stored energy source 14 in order to lock the stored energy source 14 to the coupling unit 12. This also establishes an electrical connection between a plug interface 24 of the coupling unit 12, which is designed as a plug connection, and a plug connector, which is arranged in the non-visible end face of the stored energy source 14.

The coupling unit 12 includes a connection module 26, which is integrated in the coupling unit 12 in the example shown here.

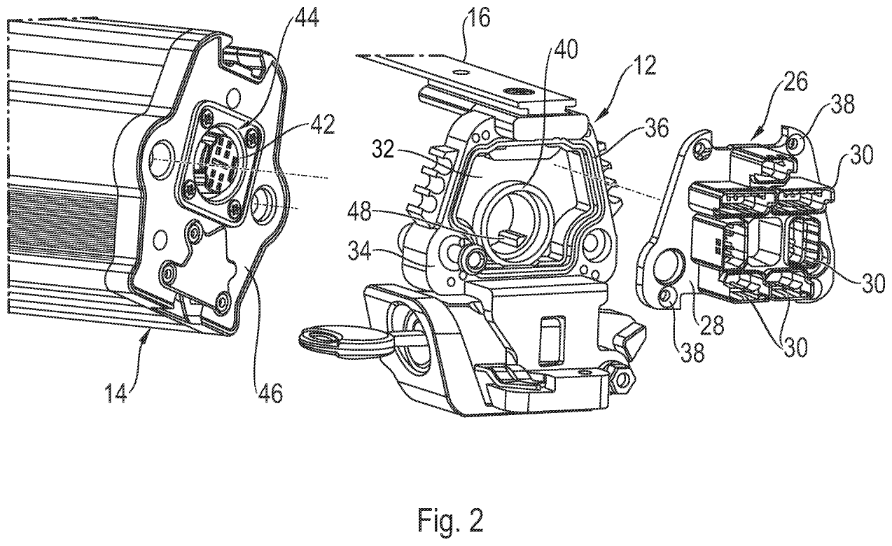

FIG. 2 shows a detailed drawing of the coupling unit 12 with a part of the retaining rail 16 as well as the connection module 26 and the stored energy source 14 (in part). The connection module 26 is designed as a plate 28 and includes the plug interface 24, which cannot be seen here, on the rear side of the plate 28 as well as several connection interfaces 30, wherein the connection interfaces 30 are arranged on the side of the plate 28 opposite the connector interface.

The coupling unit 12 has a recess 32 into which the connection module 26 extends at least partially. A frame 36 projecting beyond a contact surface 34 of the rear side of the coupling unit 12 frames the recess 32. The frame 36 may, for example, be in the form of a seal. In this way, the plate 28 of the connection module can rest against the contact surface 34 and can be fixed to the coupling unit 12 with fasteners in the form of screws. For this purpose, corresponding holes 38 are provided in the plate 28, which fit together with holes in the coupling unit. The space formed by the recess 32 and the plate 28 can be used to accommodate components or cabling. The plate has a recess on the upper side into which the retaining rail extends, so that the plate 28 is flush with the retaining rail 16. Another recess at the lower end of the plate 28 corresponds to a housing part of the coupling unit 12, so that a flush finish is formed with the coupling unit.

A guide channel 40 is provided in the recess 32 and protrudes in the form of a cylinder beyond the coupling side of the coupling unit facing the battery. The cylindrical guide channel 40 corresponds to a groove 42 in a plug connector 44 of the stored energy source 14 at the end face 46. The plug interface 24 of the connection module 26 protrudes into the guide channel 40 when the connection module 26 is fixed to the coupling unit 12. The plug interface 24 and guide channel 40 together form the plug connection, as shown in FIG. 1. It establishes the connection to the plug connector 44 of the stored energy source 14. An optional guide lug 48 in the guide channel 40 ensures an improved connection.

The connection module 26 can include several electronic components that can be integrated into the coupling unit 12 of the holding device 10. This means that any peripherals of the electric two-wheeled vehicle can be plugged in by plug interface and supplied with power directly during assembly. No further electronic distributor is required.

The plug interface 24 can preferably have the form of a plug 50 (FIG. 1), which corresponds to the plug connector 44 of the stored energy source 14, which is designed as a socket.

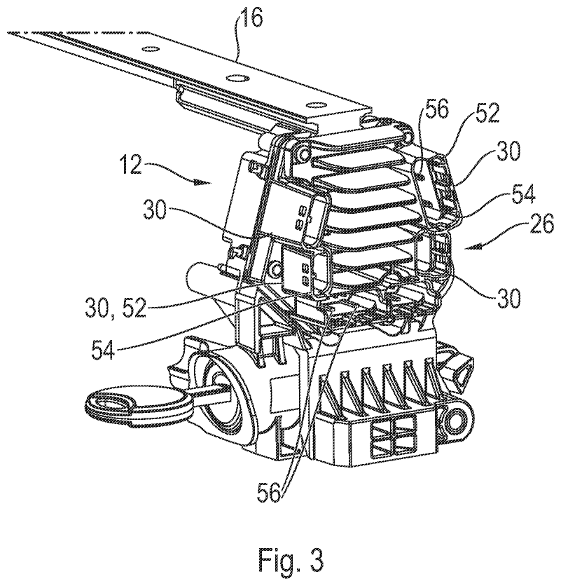

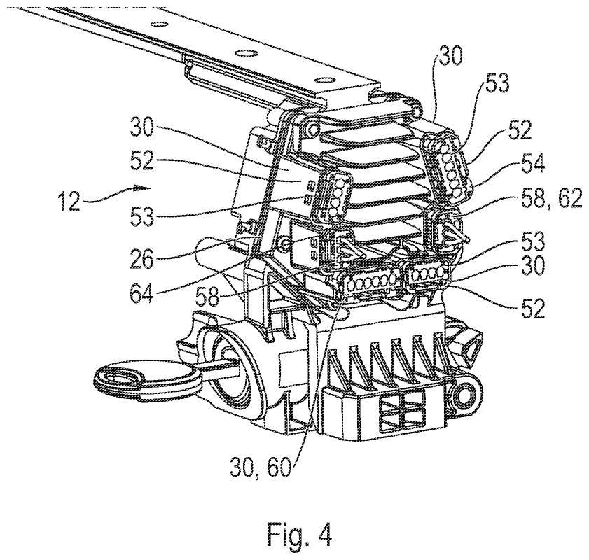

FIGS. 3 and 4 show an alternative example embodiment of a coupling unit 12 with connection module 26. According to FIG. 3, the six connection interfaces 30 are designed as a connection plug 52, which corresponds to a connection connector 58 of a component of the electrical branch circuit. The connection plug 52 has a collar 54, which serves to receive and hold a terminal connector of a component. The terminal connector can, for example, be designed as a socket. The connection plug 52 has one or more pins 56, which correspond to a socket of a terminal connector and enable a plug-in connection. When connected, the pins 56 of the connection plug 52 are received in corresponding receptacles in the sockets of the terminal connector so that an electrical contact is established.

FIG. 4 shows the example embodiment according to FIG. 3 of the connection module 26, but four of the six terminal connectors 52 are equipped with wireless connectors 53, while two terminal connectors 52 are connected to corresponding terminal connectors 58 with cables that can lead to individual components of the electrical two-wheeled vehicle. Different connection interfaces 30 are also provided here, which can have a different number of plugs and pins. Possible components of the electric two-wheeled vehicle that can be connected to the connection module 26 and supplied with energy from the stored energy source 14 are, for example, the drive motor, tail light and front light, a possible ABS unit, an operating unit or an HMI (Human Machine Interface).

A separate connection interface 30 is used for the electrical connection to a charging port of the electric two-wheeled vehicle, via which the stored energy source 14 is charged. In addition, freely usable plug connections, for example CAN plugs, can be provided in order to supply an electronic gearshift with energy, for example. In the example shown here, an engine connection interface 60 is unassigned, while a charging port connection interface 62 and a tail light connection interface 64 are assigned.

The use of different connection modules for the electrical connection to the same coupling units can lead to a high degree of flexibility during installation and to a reduction in costs. Differently configured electric two-wheeled vehicles often have different terminal connectors and connection cables for the components installed in the two-wheeled vehicle. In this way, material, costs and weight can be saved if only the necessary electrical supply lines and connections are installed.

The invention has been comprehensively described and explained with reference to the drawings and the description. The description and explanation are to be understood as examples and not limiting. The invention is not limited to the disclosed embodiments. Other embodiments or variations will be apparent to those skilled in the art from the use of the present invention and from a detailed analysis of the drawings, the disclosure and the following claims.

In the claims, the words “comprise” and “with” do not exclude the presence of further elements or steps. The undefined article “a” or “an” does not exclude the presence of a plurality. A single element or unit may perform the functions of several of the units mentioned in the claims. The mere mention of some measures in several different dependent claims is not to be understood as meaning that a combination of these measures cannot also be used advantageously. Reference signs in the patent claims are not to be understood restrictively.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### LIST OF REFERENCE SIGNS

10 holding device
12 coupling unit
14 stored energy source
16 holding rail
18 guide elements
20 groove
22 actuating lever
24 plug interface
26 connection module
28 plate
30 connection interface
32 recess
34 contact surface
36 frame
38 hole
40 guide channel
42 groove
44 plug connector
46 end face
48 guide lug
50 plug
52 connection plug
53 wireless connector
54 collar
56 pin
58 terminal connector
60 motor connection interface
62 charging port connection interface
64 tail light connection interface

1-10. (canceled)

11. An arrangement for establishing an electrical connection of a stored energy source (14) to electrical components of a two wheeled vehicle, the arrangement comprising:
a coupling unit (12) to which the stored energy source (14) is detachably fastened; and
a connection module (26) for electrically connecting components of the two wheeled vehicle, the connection module (26) detachably connected to the coupling unit (12), the connection module (26) comprising a plug interface (24) to an electrical plug connector (44) of the stored energy source (14), the connection module (26) comprising at least one connection interface (30) for coupling terminal connectors (58) of components of the two wheeled vehicle to the connection module (26) and for supplying the components of the two wheeled vehicle with energy from the stored energy source (14).

12. The arrangement of claim 11, wherein the connection module (26) is integrated in the coupling unit (12).

13. The arrangement of claim 11, wherein the connection module (26) comprises a plate (28) insertable into a corresponding recess (32) in the coupling unit (12).

14. The arrangement of claim 13, wherein the plate (28) is insertable into the corresponding recess (32) in the coupling unit (12) such that the plate (28) is flush with the coupling unit (12).

15. The arrangement of claim 13, wherein the plug interface (24) and the connection interface (30) are arranged on opposite sides of the plate (28).

16. The arrangement of claim 11, wherein the plug interface (24) comprises a plug (50) which corresponds to the plug connector (44) of the stored energy source (14) and is couplable to the plug connector (44) in order to establish an electrical connection.

17. The arrangement of claim 11, wherein the plug (50) of the connection module (26) extends at least partially into a guide channel (40) of the coupling unit (12) in order to establish a guided connection between the plug (50) and the electrical plug connector (44) of the stored energy source (14).

18. The arrangement of claim 11, wherein the connection module (26) comprises a connection plug (52) corresponding to a terminal connector (58) of the component.

19. The arrangement of claim 18, wherein the connection plug (52) comprises a collar (54) for receiving and holding the terminal connector (58) of the component.

20. The arrangement of claim 11, wherein the connection plug (52) comprises a pin (56) corresponding to a socket of the terminal connector (58) such that the pin (56) is receivable in the socket for electrical contact establishment.

21. The arrangement of claim 11, wherein the connection module (26) comprises a plurality of connection interfaces (30), each of the connection interfaces (30) connectable to a respective terminal connector (58).

22. An electric two wheeled vehicle, comprising the arrangement of claim 11, wherein the arrangement establishes the electrical connection of the electrical stored energy source (14) to electrical components of the electric two wheeled vehicle.
